(19) United States
(12) Patent Application Publication
(10) Pub. No.: US 2014/0137148 A1
(43) Pub. Date: May 15, 2014

(54) System for Managing the Streaming and Recording of Audiovisual Data

(71) Applicant: Carlos Augusto da Cruz Marques, Campinas (BR)

(72) Inventor: Carlos Augusto da Cruz Marques, Campinas (BR)

(73) Assignee: KELPIE BR GESTÃO EMPRESARIAL LTDA., Campinas (BR)

(21) Appl. No.: 14/126,582

(22) PCT Filed: May 24, 2012
(86) PCT No.: PCT/BR2012/000156

§ 371 Date: Dec. 16, 2013

(30) Foreign Application Priority Data
May 14, 2012 (BR) PI 1020120113783

(51) Int. Cl. H04N 21/258; H04N 21/433

(52) U.S. Cl. CPC H04N 21/25816; H04N 21/4334
USPC 725/25

(57) ABSTRACT

A system for managing the streaming and recording of audiovisual data in the web providing the recording and management of the flow of audiovisual data, including the flow of work, replication and transmission via web, having a notably easy installation, operation and administration.

### FIELD OF THE INVENTION

The present patent of invention relates to an inventive solution in information technology, notably in the field of automation systems and data management.

### BACKGROUND OF THE INVENTION

The market is always looking for new sustainable business alternatives for reaching the public, and this, in turn, has at its disposal, increasingly more new ways for communicating. Among the different ways of communication, electronic media has been bringing the largest amount of ways for interacting, reaching many different audiences in all senses. Online electronic media have been the path for companies that want to expand their horizons in search for globalizing their businesses, allowing more publicity for their products/services. There are interesting alternatives and complements for already existing media. In the past, only telephones were used for long distance communication. Now, it is possible to visualize people via Internet through a videoconference or through a cell phone video call.

Thus, digital convergence is increasingly present in our daily lives, either in smartphones or tablets or in advances that the internet has provided. The possibilities for integration of digital technologies in multimedia are endless. The interactivity and convenience that these new forms of communication bring have become a great advantage for doing business. Many fields of business have chosen to, in addition to the so-called “physical”, also start in the interactive or virtual media due to these advantages. Some examples are virtual stores or e-commerce, which today are alternatives for commercializing products and/or services aiming to meet all of the national and international market. Today, most of the retail businesses also have their e-commerce for serving a larger public and increasing sales.

With this way of commercialization, companies can reduce some costs, maintaining the competitive prices of their products. Additionally, they are available 24 hours a day, seven days a week, among a number of benefits, including environmental ones. Thus, some business models can also migrate to the so-called virtual environment.

For the purpose of the present invention and for better understanding of the invention in the form of an inventive information system, the technical terms and embedded technologies are defined.

WEB: World Wide Web, also known as Web or WWW, is a system for hypermedia documents that are interconnected and executed in the Internet.

Streaming, flow, or media streaming, is a way for distributing multimedia information in a network through packets. It is frequently used for distributing multimedia content through the Internet. In streaming, media information are not usually archived by the user that is receiving the stream (except for temporary archiving in the system cache or when the user actively makes the data recording)—the media is usually constantly reproduced as it reaches the user if their band is enough for reproducing the media in real time.

Webcam or web camera is a low cost video camera which captures images and transfers them to a computer. It can be used for videoconferencing, environment monitoring, video and image production for editing, among other applications. Currently, there are low or high resolution webcams (above 2.0 megapixels) and with or without coupled microphones. Some webcams come with LEDs (light emitting diodes), which light up the environment when there is little or no external light. Most webcams are connected to the computer via USB connections, and the image capture is accomplished by an electronic component called CCD.

Online or on-line, or even in line, is an Anglicism originating from the use of the Internet, in line being a literal translation from on-line, very little used in Portuguese; and “being online” or “being in line” means “being available live”. In the context of a website, it means being available for immediate access to an Internet page, in real time. In instantaneous communication, it means being ready for the immediate data transmission, spoken or written. In the context of another information system, it means being in full operation, according to functions performed in this network or system.

Conversely, being offline (or off-line) represents the unavailability of user access to the web or to the communication system. There is, in Portuguese, in this sense, the expression “offline”, which is of much less frequent use.

It is also used in Portuguese the literal translation of the English term—“online”—with the metonymic sense of being connected to a network or communication system. The terms also have the clearer meaning of “live”, “connected” or “on”.

Multimedia: it studies new media [or means] for transmitting messages, their languages and impact in society. In a more technical manner, it studies the field of multimedia, in all its scope.

Desktop or computer case (not to be confused with CPU) is a box, usually made of metal, which houses the computer. A term popularly used for describing “microcomputer” in abbreviated form.

ADSL—Asymmetric Digital Subscriber Line is a DSL format, a data communication technology that allows transmission of data via telephone lines faster than a conventional modem can.

WiMAX, IEEE standard 802.6, completed in October 2001 and published in Apr. 8, 2002, specifies a wireless metropolitan area network (WMAN). The name WiMAX (Worldwide Interoperability for Microwave Access) was attributed to this standard. The term WiMAX was created by a group of industries known for having as their goal the compatibility and interoperability between equipment based in IEEE standard 802.16. This standard is similar to Wi-Fi standard (IEEE 802.11), which is already much disseminated, but aggregates knowledge and resources that are more recent, aiming for a better performance of communication. The WiMAX standard has as a goal establishing the final broadband connection infrastructure part (last mile), offering connectivity for domestic, corporate and hotspot use.

Packet: in computer networks or telecommunication, the term packet, plot or datagram is a data transmission unitary structure or a data sequence transmitted by a network or communication line that uses packet switching. The information to be transmitted usually is broken into a number of packets and then transmitted. Aside from the information part, the packet has a header, which contains important information for the transmission, such as the receiver address, checksum, priorities, and others. A packet must be complete, without depending on previous exchanges, because there is no connection or fixed length between two points of communication, as occurs, for example, in most of voice telephone conversations. If the packet switching network is of datagram type, each packet has an independent treatment, without any connection to the treatment given to previous packet nodes.

Hardware can be defined as a general term for equipment such as keys, locks, hinges, latches, handles, wires, chains, tubing material, tools, utensils, silverware and machine parts. In the electronics scope, the term hardware is widely used, mainly in the field of computing, and applies to a central processing unit, memory and input and output devices. The term hardware is used for referring to specific details of a given machine, including its detailed logical project, as well as the packaging technology of the machine.

In addition to hardware, software is the logical part, the set of instructions and data processed by hardware electronic circuits. Every interaction of modern computer users is accomplished via software, which is the layer placed above hardware, which transforms the computer into something useful to the human being.

The term Hardware does not relate only to personal computers, but also to embedded equipment in products that need computational processing, such as devices found in hospital, automobile, cell phone, and other equipment.

In the science of computing, the subject that relates to the hardware project solutions is known as computer architecture. For accounting and financial purposes, the hardware is considered a capital asset.

Encoder, in the context of computing, an encoder is a software used for decoding certain files (usually music or video) aiming to obtain a standardization and a better quality and/or smaller size for storage.

Flash Player (TRDEMARK) is a media player software that executes files containing multimedia in general.

RTMP Protocol, Real Time Messaging Protocol, which is nothing more than a protocol developed for audio, video and data streaming for the Internet totally aimed at the Flash Player software, wherein the protocol is very simple and traffics in TCP at port 1935. It is also possible to use RTMPT protocol that uses small HTTP packets for breaching Firewalls, RTMPS and RTMPTS, which are the same protocols, but in safe connection.

Framework is an abstraction that unifies common codes in many software projects, providing a generic feature. A framework can achieve a specific feature, by configuration, during the programming of an application. As opposed to libraries, it is the framework that dictates the control flow of the application, called Control Inversion.

Plug-in: in computing, a plug-in or an extension module, also known as plug-in, add-in, add-on, is a computer software used for adding functions to other larger software, providing some special or very specific feature. Usually small and light, it is used only on demand. An application can use such technique for several reasons, such as allowing external software developers to extend their product features, support previously unknown features, reduce the file size or even separate the source code from different components due to software license incompatibility.

ActionScript is an ECMAScript-based object oriented language used mainly for building RIA applications (Rich Internet Applications). It is run in a virtual machine (AVM—“ActionScript Virtual Machine”), currently in version 3, which is available in Adobe Flash Player (plug-in found in web browsers).

Website or web is a set of web pages, i.e., hypertexts accessible usually by the Internet HTTP protocol. The set of all existing public websites makes up the World Wide Web. The pages in a website are arranged from a basic URL, or website, where the main page is, and usually lie in the same server directory. The pages are arranged within a website in a hierarchy that is observable in the URL, although the hyperlinks between them control the way in which the reader perceives the global structure, such mode having little to do with the hierarchical structure of the website files. Some websites, or parts of websites, demand a subscription, with the payment of a fee, for example, a monthly fee, or only a free register. The examples include many porn websites, parts of news websites, websites that provide real time financial market data and the Encyclopedia Britannica.

Cryptography, encrypting is the process of transforming information referred to as original text using an algorithm (called cypher) so as to preclude the reading for all but those who have a particular information, usually referred to as a key. The result of this process is the encrypted information (referred to as cyphered text in cryptography). In some contexts, the term encrypting also refers implicitly to the reverse process, decrypting (for example “encrypting software” typically performs decryption), in order to make the encrypted information readable again (i.e., make it decrypted).

Algorithm is a finite sequence of well-defined and non-ambiguous instructions, each of which can be performed mechanically in a finite period of time and with a finite amount of effort.

The concept of algorithm is frequently illustrated by the example of a food recipe, although many algorithms are more complex. They can repeat steps (make iterations) or need decisions (such as comparisons or logic) until the task is completed. A correctly executed algorithm will not solve a problem if it is implemented incorrectly or if it is not appropriate to the problem. An algorithm does not represent necessarily a computer software, but steps needed for performing a task. Its implementations can be made by a computer, by other kind of automaton or even by a human being. Different algorithms can perform the same task using a different set of instructions in more or less time, space, and effort, than others do. Such difference can be a reflection of the computational complexity applied, which depends on data structures adequate to the algorithm. For example, an algorithm for getting dressed can specify that you first put on the socks and shoes before putting on the pants, while another algorithm specifies that you should first put on the pants and then the socks and shoes. It is clear that the first algorithm is more difficult to perform than the second one, although both take you to the same result.

Embedded technology of an inventive system: currently, with the advent of information technologies such as ADSL (Asymmetric Digital Subscriber Line), Internet via cable, via radio, WiMAX and optical fiber, allow the consolidation of new Internet businesses, such as, for example, video on demand. It is also already possible to watch streaming videos via smartphone or on your computer screen, a technology that has enabled many people around the world to have access to content via the Internet. For example, people in Brazil can watch and listen to TV and Radio from other countries without the need of leaving the country, only through a computer connected to the Internet.

As a rule, Streaming technology has its concept based on streaming, notably media streaming, which is a way to distribute multimedia information in a network through packets. It is frequently used to distribute multimedia content through the Internet.

It is known that generating an information managing system for audiovisual information that is highly versatile, with embedded technology allowing the data recording to run through any type of equipment that captures the audiovisual content is in high demand, specially one that can be generated without the need of professional equipment, for example, via a webcam device connected to a computer, or even via a mobile device (smartphone, tablet, etc.).

Additionally, there is a need for organizational processes that are structured with the presence of the “paper tool” for many purposes, but mainly when there is a need for legal support and proof of any transaction or deal performed.

Concerns with the environment is a topic highlighted in today's society. Issues related to the productivity of resource use are paramount to the success of today's businesses.

### SUMMARY OF THE INVENTION

The present invention seeks to provide a solution in information technology, notably in the field of automation systems and data management, such as audio and or video data, originated from both the research and for the context of production and digital reproduction. The present invention can be used in videoconferencing, audio and video transmissions, benefiting from the use of “streaming” technology, wherein its content is capable of being recorded. This means that the audiovisual content can be transmitted live and recorded simultaneously for later analysis by personnel dedicated to the subject matter in question, or even previously recorded and retransmitted.

The present invention also seeks to provide a system particularly useful in companies and organizations for hiring and selection processes, staff meetings, promoting hearings in the legal sphere, medical distance/remote communication, psychological counseling and therapy, in education, for promoting distance teaching, lectures, workshops, training and meeting, promoting greater agility, reliability and transparency, without the need of special infrastructure.

The present invention enables presenting specific consumers with an information system lies in enabling interactivity between users through a virtual environment, allowing, the conversation, either in audio or video, to occur in real time and in the same environment. This will further allow the exchange of files of the most varied platforms, ensuring, thus, online presentations via desktop between one or more people. The recording of the event is possible, wherein, in order to do so, the persons involved just need to each have the minimum requirements for communication, i.e., a microcomputer with internet access provided with a webcam and an audio system with microphone.

The present invention seeks to provide a system for managing the streaming and recording of audiovisual data comprising: (i) a first streaming station [Es1] generates a first streaming emitting a request for audio and video transmission [Ca] to a server [Se] generates a first access key; (ii) the server [Se] receives the audio and video transmission and decodes and compresses the requested information from the first streaming station [Es1] and emits the decoded and compressed streaming to a second streaming station [Es2]; (iii) the second streaming station [Es2], authenticates the first access key, and responds [Re] to the server [Se] a corresponding requested recorded audio and video transmission [Ca]; and generates a second access key [ch2]; iv. the server [Se] receives the response with the requested recorded audio and video transmission [Ca]; encodes and compresses the transmission; and transmitsto the synchronization station [Si] v. a synchronization station [Si], connected to the internet, receives the encoded and compressed transmission of audio and video from the media server [Se] and synchronies the transmission of audio and video [Ca] from the first streaming station [Es1] and second streaming station [Es2]; vi. a hard disk drive receives and stores the synchronized recorded audio and video file, and vii. the synchronized recorded audio and video file [Ca] in the hard disk drive is transmitted in real time to an end user [Us], through the internet connection or is stored for later use.

The present invention also seeks to provide a system for managing the streaming and recording of audiovisual data comprising: (I) a first encoding station [Es], receives an audio and visual information and transmits the real time audio and visual information [Ca] to a media server equipment [Se]; (II) the media server equipment [Se] receives the real time audio and visual information from the first encoding station [Es]; decodes, compresses and reproduces [Re] the real time audio and visual information to a receiving user [Us]; and (III) the receiving user [Us] receives the decoded, compressed and reproduced [Re] real time audio and visual information from the server equipment and reproduces the decoded, compressed and reproduced [Re] audio and visual information in real time or temporarily records the decoded, compressed and reproduced [Re] real time audio and visual information in a system cache or in a memory device.

### BRIEF DESCRIPTION OF THE DRAWINGS

FIG. 1 is an illustrative representation of the information system with the architecture anchored in Streaming.

FIG. 2 is a second illustrative representation of the information system.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative.

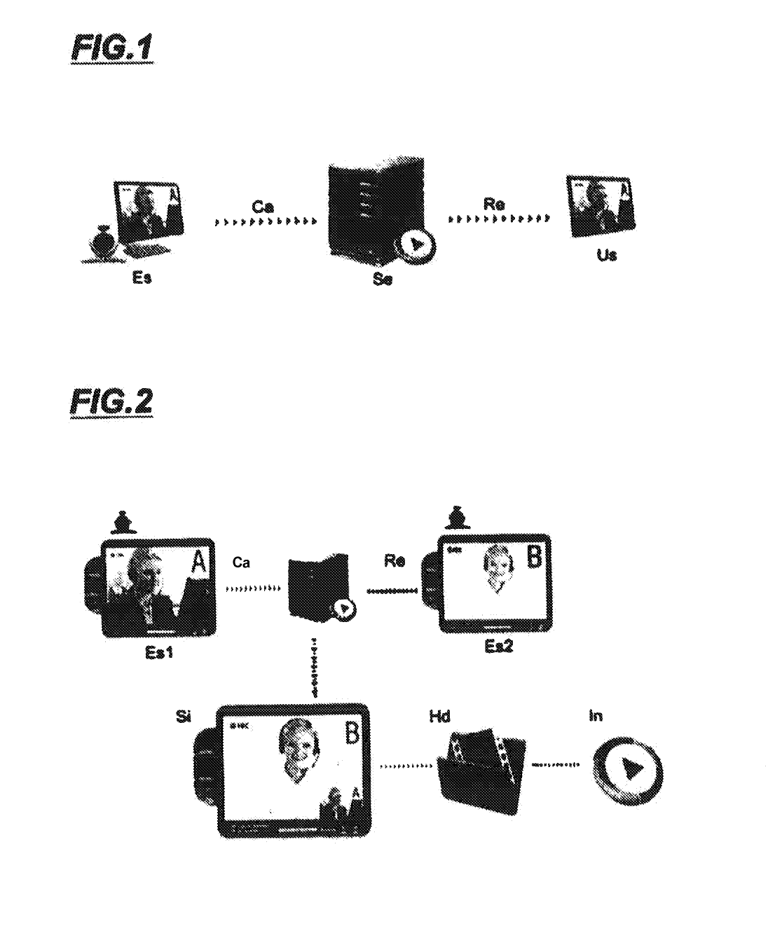

In a first embodiment of the invention, FIG. 1 illustrates the information system that supports the demand of the present invention, so that the architecture comprises:
Encoding station [Es, having the function of receiving audio and visual information and its later transmission to the server equipment;
Server equipment [Se], with decoding, compression and transmission functions;
Receiving user [Us]; which is the receiver of the information decoded, compressed and transmitted by the server equipment [Se].

A relevant fact in this deciphered architecture is that the server receives [Ca], in real time, information originating from the encoding station [Es] and further reproduces [Re] and transmits in real time the information treated for the end user [Us].

In streaming, media information, i.e. the content, is not usually archived by the user [Us] who is receiving/watching. In turn, such information will also not be archived temporarily in the system cache or in devices (hardware) in which the user [Us] actively records data. The media usually is constantly reproduced as it reaches the user [Us]; if their band is enough, it will be able to reproduce the media in real time.

Live transmission uses the concept of streaming, which enables the audiovisual content to be delivered to the end user [Us] in a continuous flow, wherein the transmission starts as the download of the content also starts. The end user can watch the transmission in real time, as it arrives, without having to wait for the full download of the archive, having the great advantage of not being stored in the computer.

Regarding the streaming associated with recording, the system for managing streaming and recording of audiovisual data presents distinctive feature by the relevant fact of enabling the recording of a live transmission, i.e., in real time, wherein the entire content already benefited by the transmission with streaming technology can be recorded for later use, either for educational or commercial reproduction of the content, once it is stored in servers and duly identified.

One of the benefits of the novel system is that people are often not available to everyone at any moment, being humanely impossible to be in more than one place at the same time. Based on this premise, the use of the platform of the system of the present invention allows the user to participate in an online meeting, also known as videoconference, having as a highlight the novelty of recording this section for later knowledge of the absent people who could not attend the section.

As additional uses and applications of the inventive information system, without underestimating the importance of its goal, we can cite the proof of a test applied in a given course through a testimony, in a condominium meeting, a meeting between shareholders of a company, the council of a club and or organization.

Every event can occur in the convenience of their home or even their workplace, thus, avoiding unnecessary travel.

Lastly, the information system of the present invention brings credibility through the proof of its communication content recorded in a non-editable manner, as the “parties” have no direct access to the file resulting from the recording, for being in a repository (data center or cloud computing). The access can then be directly connected to the “ID” or to your social security digital certificate, such as e-CPF, and or digital certificate of a physical person of authority in the art, who shall give veracity and attest the testimony of both, similar to what occurs in the drafting of an accidental report or a Notarial Act, where, by the so-called notarial act through which a notary—requested by the interested party—drafts a public instrument formalized by the faithful narrative of everything that they have verified by their own senses without issuing an opinion, value judgment or conclusion. The same may also serve as a pre-constituted proof for use in the legal, extrajudicial and administrative spheres, so that the truth (juris tantum) of the facts stated therein can only be attacked by an incident of falsehood through the final judgment, everything witnessed and reported represents the truth consigned to the digital files, herein denoted simply as video, which shall substitute the faithful and notorious transcript of the testimony in person in notarial books, earning maximum veracity of identity enhanced by the image and voice of the deponent associated with notarial authority.

The operational logic of the system of the present invention is below:

[a] reception of an event: which can be through video cameras connected to as Encoding station [Es] (in a simpler scenario, a webcam connected to a computer, for example), connected to a Media Server [Se] which captures and encodes the content (audio+video) within a previously established compression rates, always maintaining an optimal relation between compression rates and image quality.

The system is defined by a platform that uses servers and software for ensuring high quality of live transmission without demanding too much processing from an end user [Us] computer.

[b]transmission upload: after compression and encoding of the content, the upload of the transmission to the media server [Se] begins, which will be responsible for delivering the content to the end user [Us].

[c] content availability: upon receiving the content, the media server [Se] provides the content to each end user [Us] connected to the transmission via the Internet. The total band of the server [Se] must be large enough to accommodate all the simultaneous requests of each end user [Us], and will be responsible for delivering to the end user [Us] a stable content, having audio and video quality and no interruptions. In this configuration, the end user [Us] only needs a computer with average processor and memory, and having a software that executes files containing multimedia (Flash Player TRADEMARK) application installed.

[d] content treatment: using RTMP protocol (Real Time Messaging Protocol), the system interprets, in a imperative and object-oriented way, with a dynamic and strong typing which prioritizes code readability over speed or expressiveness. It combines a concise and clear syntax with powerful resources of its default library and by modules and frameworks developed by third parties.

In order to make such operational step feasible, an exclusive plug-in has been developed (or extension module—also known as plug-in, add-in, add-on) to a computer software, used for adding functions to other larger software, providing some special and or very specific feature. It is usually small and light, conceived in an object-oriented language, such as ACTION SCRIPT 3 (TRADEMARK) language, which allow the addition of resources and improvement of the tool.

This plug-in allows full control of sound and image quality, as well as predefined adjustments in relation to the difference in speed of transmission of data between two ends, including:
FPS (frames per second) camera
buffer Time (temporary memory used)
rate (transmission rate)
quality
video Codec (video decoder)
camera quality (image quality)

[e] content availability: in the occurrence of a request through an unique key created by an end A, a primary channel (1^{st} streaming) is opened, this stays in standby waiting for an end B (2^{nd} streaming) which will only be able to connect if it has an access key that will be authenticated by the system. Once it has the access key, the end B connects to the end A and data transfer starts automatically and, as a consequence, a recording.

Each end transmits image and sound to the system, and the encoder [Es] is responsible for recording each streaming in a single disk, in this case, commanded by an interlocutor, which will be “heading up” or in command of the call and storing and managing with first and second access keys [ch1] and [ch2].

The recording only occurs when end B is authenticated by the system, so that the automatic synchronization of both ends is ensured, thus, not generating unnecessary content.

Each streaming is recorded in a disk in the *.FLV format.

The connection security is unquestionable, because, as end

A generates a unique access key for accessing the data transfer, the system only allows the other end to authenticate if it has this unique key. This avoids undue or undesirable use of the data transfer channel.
[f] Content encryption: the entire content generated is encrypted, i.e., goes through the process of transforming information using an algorithm (called cypher) so as to preclude its reading to all but those who have a particular information, usually referred to as access key.

A plug-in has been developed for accepting and automatically starting to record when end B authenticates in the Media Server, once end A is already authenticated, displaying at a screen of all participants

### EXAMPLE OF APPLICATION

a. System architecture: in an embodiment, the inventive system has the architecture disclosed in FIG. 2, composed by:
A media server [Se];
A first streaming station [Es1]: transmits to the server [Se] a transmission of audio and video, where an access key is generated [ch1];
A second streaming station [Es2]: responds to server [Se] the transmission of audio and video, where first access key [ch1] is located, and authenticates a second access key [ch2]
A synchronization station [Si];
A file storage hard disk [HD]; Internet connection [In].

b. System operation:
b.1. A first streaming station [Es1] generates the first streaming, where it emits a request for audio and video transmission [Ca] to a server [Se], as well as generates a first access key [ch1];
b.2 The server [Se] treats (encodes and compresses) the requested information in the first streaming station [Es1] and emits these data to a second streaming station [Es2];
b.3 In the second streaming station [Es2], a checking of the first access key [ch1] is made, authenticating it and, once the data received from server [Se] are confirmed, the second station [Es2] responds [Re] transmitting to the server [Se] the corresponding requested recorded data, and generates a second access key [ch2];
b.4 The server [Se] receives the requested recorded data and proceeds to the treatment thereof, encoding them, compressing them and finally transmitting them to a synchronization station [Si];
b.5 In the synchronization station [Si] a simultaneous synchronization of the recording is made;
b.6 With the synchronization completed, the synchronization station [Si] proceeds to the generation of a synchronized recording file which is stored in a hard disk drive [HD];
b.7 The synchronized recording stored in the hard disk drive [HD] is connected, at any moment, to an internet connection (sharing link) [ln] and may be transmitted in real time for an end user [Us] or recorded for later use.
   It should be understood that the preferred embodiments mentioned here are merely illustrative of the present invention. Numerous variations in design and use of the present invention may be contemplated in view of the following claims without straying from the intended scope and field of the invention herein disclosed.

1-2. (canceled)

3. A system for managing the streaming and recording of audiovisual data, the system comprising:
(a) an internet connection [In];
(b) a media server equipment [Se] constructed and arranged to generate a first access key [ch1];
(c) a first streaming station [Es1] connected to the media server equipment [Se] and constructed and arranged to request a transmission of audio and video from the media server [Se];
(d) a second streaming station [Es2] connected to the media server equipment [Se] and constructed and arranged to authenticate the first access key [ch1];
to respond [Re] to the transmission of audio and video to the media server [Se], and to generate a second access key [ch2];
(e) a synchronization station [Si], connected to the internet connection and connected to the media server equipment [Se] and constructed and arranged to receive encoded and compressed transmission of audio and video from the media server [Se] and synchronizing the transmission of audio and video from the first streaming station [Es1] and second streaming station [Es2];
(f) a file storage hard disk connected to the synchronization station [Si] and constructed and arranged to receiving and storing the synchronized recorded audio and video; and to transmit the synchronized recorded audio and video file to an end user [Us].

4. A system for managing the streaming and recording of audiovisual data comprising the following steps:
i. a first streaming station [Es1] generates a first streaming emitting a request for audio and video transmission [Ca] to a server [Se] generates a first access key;
ii. the server [Se] receives the audio and video transmission and decodes and compresses the requested information from the first streaming station [Es1] and emits the decoded and compressed streaming to a second streaming station [Es2];
iii. the second streaming station [Es2], authenticates the first access key, and responds [Re] to the server [Se] a corresponding requested recorded audio and video transmission [Ca]; and generates a second access key [ch2];
iv. the server [Se] receives the response with the requested recorded audio and video transmission [Ca]; encodes and compresses the transmission; and transmitsto the synchronization station [Si].
